(19) United States
(12) Patent Application Publication
(10) Pub. No.: US 2002/0166461 A1
(43) Pub. Date: Nov. 14, 2002

(54) Portable food warming system

(76) Inventor: Pam Johnson, Walnut, CA (US)

Correspondence Address: Richard W. Goldstein, 2071 Clove Road, Staten Island, NY, 10304, US

(21) Appl. No.: 09/854,746

(22) Filed: May 14, 2001

(51) Int. Cl. A01J 11/04; A01J 13/00; A23C 3/02; A23C 15/04

(52) U.S. Cl. 99/483; 99/467

(57) ABSTRACT

A portable food warming system including a platter portion having a peripheral edge. The peripheral edge has an upwardly extending lip secured thereto. The platter portion is formed with an insulated material. A cover portion is provided that is dimensioned for covering the platter portion. The cover portion has an insulated inner layer. The cover portion has a closed upper end and an open lower end. The open lower end receives the platter portion therein.

### CROSS REFERENCES AND RELATED SUBJECT MATTER

This application relates to subject matter contained in utility patent application Ser. No. 09/511,510, filed in the United States Patent & Trademark Office on Feb. 23, 2000.

### BACKGROUND OF THE INVENTION

The present invention relates to a portable food warming system and more particularly pertains to keeping food items warm while waiting to be eaten.

The use of food warmers is known in the prior art. More specifically, food warmers heretofore devised and utilized for the purpose of keeping large quantities of food warm are known to consist basically of familiar, expected and obvious structural configurations, notwithstanding the myriad of designs encompassed by the crowded prior art which have been developed for the fulfillment of countless objectives and requirements.

While these devices fulfill their respective, particular objective and requirements, these patents do not describe a portable food warming system for keeping food items warm while waiting to be eaten.

In this respect, the portable food warming system according to the present invention substantially departs from the conventional concepts and designs of the prior art, and in doing so provides an apparatus primarily developed for the purpose of keeping food items warm while waiting to be eaten.

Therefore, it can be appreciated that there exists a continuing need for a new and improved portable food warming system which can be used for keeping food items warm while waiting to be eaten. In this regard, the present invention substantially fulfills this need.

### SUMMARY OF THE INVENTION

In the view of the foregoing disadvantages inherent in the known types of food warmers now present in the prior art, the present invention provides an improved portable food warming system. As such, the general purpose of the present invention, which will be described subsequently in greater detail, is to provide a new and improved portable food warming system which has all the advantages of the prior art and none of the disadvantages.

To attain this, the present invention essentially comprises a platter portion having a generally rectangular configuration. The platter portion includes a peripheral edge. The peripheral edge has an upwardly extending lip secured thereto. The platter portion is formed with an insulated material. A cover portion is provided that is dimensioned for covering the platter portion. The cover portion has a generally circular configuration. The cover portion has a plastic outer layer and an insulated inner layer. The cover portion has a closed upper end and an open lower end. The open lower end receives the platter portion therein. The closed upper end has a central recess formed therein. The central recess has a handle secured thereto.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved portable food warming system which has all the advantages of the prior art food warmers and none of the disadvantages.

It is another object of the present invention to provide a new and improved portable food warming system which may be easily and efficiently manufactured and marketed.

It is a further object of the present invention to provide a new and improved portable food warming system which is of durable and reliable construction.

An even further object of the present invention is to provide a new and improved portable food warming system which is susceptible of a low cost of manufacture with regard to both materials and labor, and which accordingly is then susceptible of low prices of sale to the consuming public, thereby making such a portable food warming system economically available to the buying public.

Even still another object of the present invention is to provide a new and improved portable food warming system for keeping food items warm while waiting to be eaten.

Lastly, it is an object of the present invention to provide a new and improved portable food warming system including a platter portion having a peripheral edge. The peripheral edge has an upwardly extending lip secured thereto. The platter portion is formed with an insulated material. A cover portion is provided that is dimensioned for covering the platter portion. The cover portion has an insulated inner layer. The cover portion has a closed upper end and an open lower end. The open lower end receives the platter portion therein.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the portable food warming system constructed in accordance with the principles of the present invention.

FIG. 2 is an elevated side view of the present invention illustrated in use.

FIG. 3 is a cross-sectional view of the present invention as taken along line 3-3 of FIG. 2.

The same reference numerals refer to the same parts through the various figures.

### DESCRIPTION OF THE PREFERRED EMBODIMENT

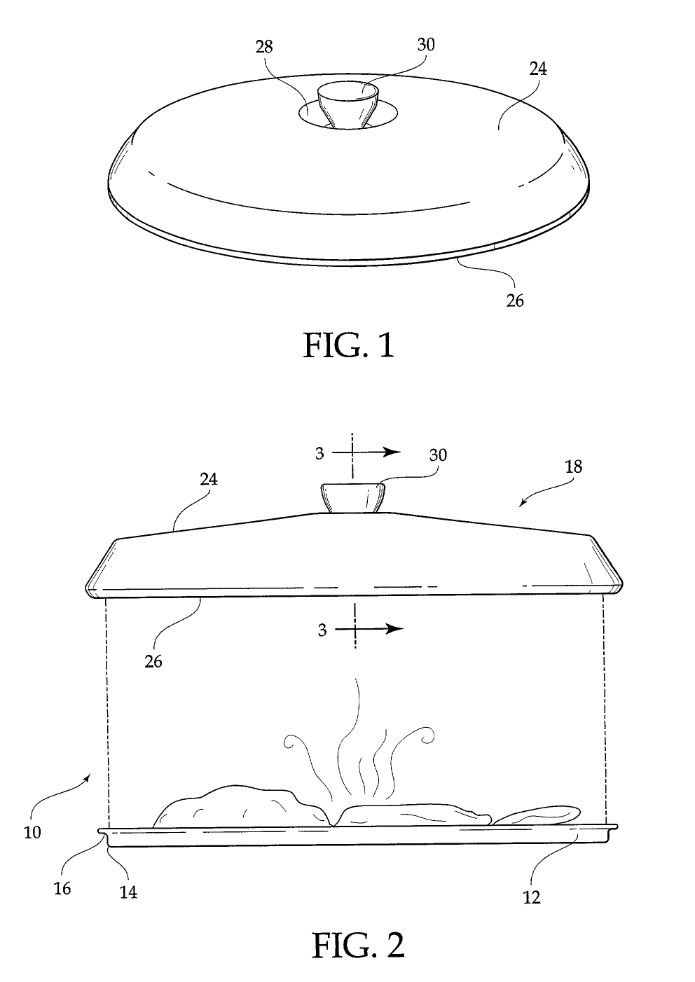

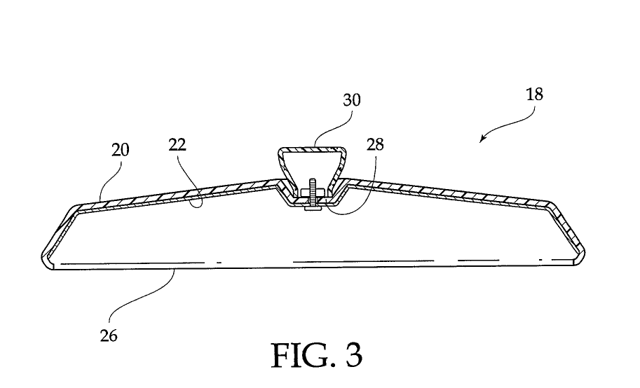

With reference now to the drawings, and in particular, to FIGS. 1 through 3 thereof, the preferred embodiment of the new and improved portable food warming system embodying the principles and concepts of the present invention and generally designated by the reference number 10 will be described.

Specifically, it will be noted in the various Figures that the device relates to a portable food warming system for keeping food items warm while waiting to be eaten. In its broadest context, the device consists of. Such components are individually configured and correlated with respect to each other so as to attain the desired objective.

The platter portion 12 has a generally rectangular configuration. Alternately, the platter portion 12 can be formed in a variety of configurations, such as square or rectangular. The platter portion 12 includes a peripheral edge 14. The peripheral edge 14 has an upwardly extending lip 16 secured thereto. The platter portion 12 is formed with an insulated material. Note FIG. 2.

The cover portion 18 is dimensioned for covering the platter portion 12. The lip 16 of the platter portion 12 enables the cover portion 18 to fit tightly around said platter portion 12. Note FIG. 2. The cover portion 18 has a generally circular configuration. As with the platter portion 12, the cover portion 18 can be constructed in a variety of configurations so as to correspond with the platter portion 12. The cover portion 18 has a plastic outer layer and 20 an insulated inner layer 22. The cover portion 18 has a closed upper end 24 and an open lower end 26. The open lower end 26 receives the platter portion 12 therein. The closed upper end 24 has a central recess 28 formed therein. The central recess 28 has a handle 30 secured thereto.

In use, prepared food is placed on the platter portion 12. The cover portion 18 is then placed over the platter portion 12 prior to the food being consumed. The cover portion 18 will contain heat and the warmth of the food so that it can be enjoyed even if the food sits for a time. The insulated inner layer 22 will prevent the food from becoming cold for a longer time. Because the cover portion 18 is provided with a plastic outer layer 20, the cover portion 18 will remain cool from the outside so as to be easily handled.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A portable food warming system for keeping food items warm while waiting to be eaten comprising, in combination:
a platter portion having a generally rectangular configuration, the platter portion including a peripheral edge, the platter portion being formed with an insulated material;
a cover portion dimensioned for covering the platter portion, the cover portion having a generally circular configuration, the cover portion having a plastic outer layer and an inner layer, the cover portion having a closed upper end and an open lower end, the open lower end receiving the platter portion therein the closed upper end having a central recess formed therein, the central recess having a handle secured thereto.

2. The portable food warming system as set forth in claim 1 wherein the inner layer of the cover portion is constructed from an insulated material.

3. The portable food warming system as set forth in claim 2, wherein the peripheral edge of the platter portion has an upwardly extending lip secured thereto, said lip enabling the cover portion to fit snugly about the platter portion.

4. The portable food warming system as set forth in claim 3 wherein the closed upper end of the cover portion has a central recess formed therein, the central recess having a handle secured thereto.
